(19) United States
(12) Patent Application Publication
(10) Pub. No.: US 2008/0000052 A1
(43) Pub. Date: Jan. 3, 2008

(54) Refrigerator

(75) Inventors: Dae Jin Hong, Jangseong-gun (KR); Gi Joong Jeong, Gwangju (KR); Yo Hyun Song, Gwangju (KR); Sang Gyu Jung, Gwangju (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/797,070

(22) Filed: Apr. 30, 2007

(30) Foreign Application Priority Data
Jun. 28, 2006 (KR) 10-2006-0058986

(51) Int. Cl. E05D 5/00

(52) U.S. Cl. 16/382

(57) ABSTRACT

A refrigerator includes a door handle, which can prevent damage of an appearance of the refrigerator or noise by an operation of the door handle, and which can permit easy opening of a door with a small force being required by a user. The refrigerator includes a door installed to a main body of the refrigerator, and the door handle installed on the door. The door handle includes a rotational member rotatably coupled with the door, a compressive member installed on the door, to linearly move in order to compress the main body, a gear connection part to convert a rotational movement of the rotational member to a linear movement of the compressive member, and a returning member to return the rotational member to an original position.

### CROSS-REFERENCE TO RELATED APPLICATIONS

This application claims the benefit of Korean Patent Application No. 10-2006-0058986, filed on Jun. 28, 2006 in the Korean Intellectual Property Office, the disclosure of which is incorporated herein by reference.

### BACKGROUND OF THE INVENTION

1. Field of the Invention

The present invention relates to a refrigerator. More particularly, to a refrigerator which includes a door handle to permit easy opening of a door by a user.

2. Description of the Related Art

A conventional refrigerator includes a large, heavy door which has a difference in pressure between an interior and an exterior of a storage compartment due to a decrease in temperature inside the storage compartment. Therefore, great force is required when a user opens the door. Accordingly, the conventional refrigerator includes a device, for example, a handle apparatus to permit opening of the door by a user.

For example, a conventional refrigerator as disclosed in EP 1174668 includes a door handle which is configured to separate the door from a main body of the refrigerator, thereby permitting opening of the door.

In FIG. 1, the door handle of the conventional refrigerator includes a rotational member 3 being rotatably coupled with a door 1, and rotating via a shaft 5, and having a handle 2 positioned at a distal end of the rotational member 3, and a compressive member 4 to open the door 1, while linearly moving via rotation of the rotational member 3. The rotational member 3 includes a round compressing part 6 at a proximate end thereof, to compress a rear end of the compressive member 4 towards the main body (not shown), when the rotational member 3 is rotated. According to FIG. 1, when a user pulls the handle 2 to open the door 1, the compressing part 6 of the rotational member 3 is forced to compress the compressive member 4, causing the compressive member 4 to move to the main body and compress a front side of the main body, so that the door 1 can be opened.

Since the compressing part 6 of the rotational member 3 rotates while compressing the rear end of the compressive member 4, when the user opens the door 1, severe friction is generated between an outer surface of the compressing part 6 and the rear end of the compressive member 4. As such, since the outer surface including paints of the compressing part 6 is likely to be abraded due to the friction, an appearance of the door can be easily damaged. Furthermore, noise can be generated due to the friction of the compressing part 6.

### SUMMARY OF THE INVENTION

Accordingly, it is an aspect of the present invention to provide a refrigerator including a door handle, which can prevent damage of an appearance of the refrigerator or noise by an operation of the door handle, and which can permit easy opening of a door with small force being required by a user.

Additional aspects and/or advantages of the invention will be set forth in part in the description which follows and, in part, will be apparent from the description, or may be learned by practice of the invention.

The foregoing and/or other aspects of the present invention are achieved by providing a refrigerator, including a door installed to a main body of the refrigerator, and a door handle installed on the door, wherein the door handle includes a rotational member rotatably coupled with the door, a compressive member installed on the door to move linearly to compress the main body, a gear connection part to convert a rotational movement of the rotational member to a linear movement of the compressive member, and a returning member to return the rotational member to an original position.

The gear connection part includes a pinion gear positioned on the rotational member, and a rack gear positioned on the compressive member to engage with the pinion gear.

The door handle further includes a stationary member fixed to a side surface of the door, the rotational member being rotatably coupled with the stationary member, and the compressive member slidably coupled with the stationary member to move linearly in an opening direction of the door.

The stationary member includes a guide groove to guide the linear movement of the compressive member, and the compressive member includes a guide protrusion entering and fitted into the guide groove.

The door handle further includes a first cover fixed to the stationary member to cover an outer surface of the compressive member, and a second cover coupled with the rotational member to cover an outer surface of the rotational member.

The stationary member comprises a resin material having a metallic reinforcing material embedded therein.

The door handle further includes a handle connected with the rotational member at a location spaced apart from a rotational center of the rotational member, such that a rotational radius of the handle is greater than that of the pinion gear.

Another aspect of the present invention is achieved by providing a refrigerator including a door installed to a main body of the refrigerator, and a door handle installed on the door, wherein the door handle includes a stationary member coupled with the door, a rotational member coupled with the stationary member to rotate via a first shaft, a compressive member coupled with the stationary member so as to move linearly to compress the main body, a first gear positioned on the rotational member, a second gear positioned on the stationary member to rotate via a second shaft, and to engage with the first gear, a link member being coupled with the second shaft to rotate along with the second gear and including a connecting shaft coupled with the compressive member at a location spaced apart from a rotational center of the link member, and a returning member to return the rotational member to an original position.

The compressive member includes an extension extending to enter a space between the first and second shafts, and a connecting groove formed on the extension to engage with the connecting shaft.

Another aspect of the present invention is achieved by providing a refrigerator including a door installed on a main body of the refrigerator, and a door handle installed on the door, wherein the door handle includes a stationary member coupled with the door, a rotational member coupled with the stationary member to rotate via a first shaft, a compressive member coupled with the stationary member, to move linearly to compress the main body, a first gear positioned on the rotational member to rotate via the first shaft, a second gear positioned on the stationary member to rotate via a second shaft and to engage with the first gear, a third gear coupled with the second shaft to rotate along with the second gear, a rack gear positioned on the compressive member to engage with the third gear, and a returning member to return the rotational member to an original position.

According to an aspect of the present invention, the first gear is an internal gear integrally formed with the rotational member.

According to an aspect of the present invention, the second gear is integrally formed with the third gear.

Another aspect of the present invention is achieved by providing a refrigerator, including a door installed to a main body of the refrigerator, and a door handle installed on the door, wherein the door handle includes a rotational member rotatably coupled with the door, the rotational member including a pinion gear formed at one side of the rotational member and a handle formed at the other side thereof, a compressive member installed to the door, to move linearly to compress the main body, the compressive member having a rack gear engaging with the pinion gear, and a returning member positioned inside the rotational member to compress and return the rotational member to an original position.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a door handle of a conventional refrigerator;

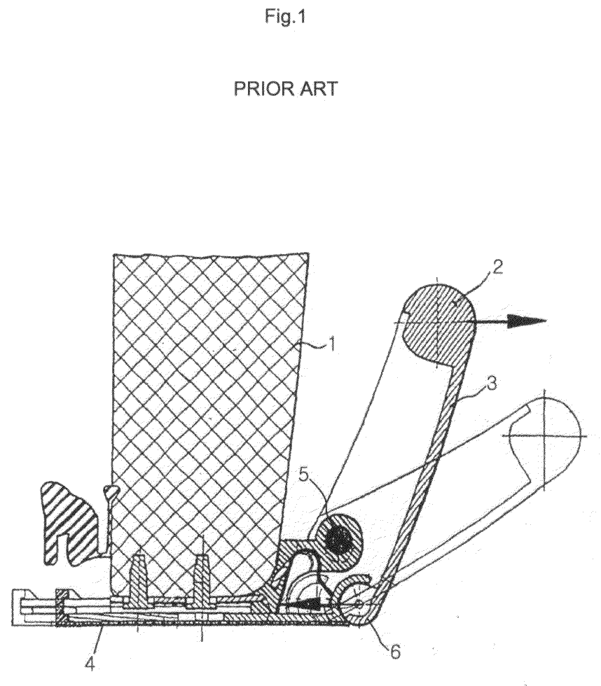

FIG. 2 is a perspective view of a refrigerator according to the present invention;

FIG. 3 is an exploded perspective view of a door handle of the refrigerator according to a first embodiment of the present invention;

FIG. 4 is a cross-sectional view of the door handle of the refrigerator according to the first embodiment, showing the door handle before an operation

FIG. 5 is a cross-sectional view of the door handle of the refrigerator according to the first embodiment, showing the door handle after the operation;

FIG. 6 is a cross-sectional view taken along line VI-VI′ of FIG. 4;

FIG. 7 is a perspective view illustrating a main part of a door handle of the refrigerator according to a second embodiment of the present invention;

FIG. 8 is an exploded perspective view illustrating the main part of the door handle of the refrigerator according to the second embodiment;

FIG. 9 is a perspective view illustrating a main part of a door handle of the refrigerator according to a third embodiment of the present invention; and

FIG. 10 is an exploded perspective view illustrating the main part of the door handle of the refrigerator according to the third embodiment.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout the drawings. The embodiments are described below to explain the present invention by referring to the figures.

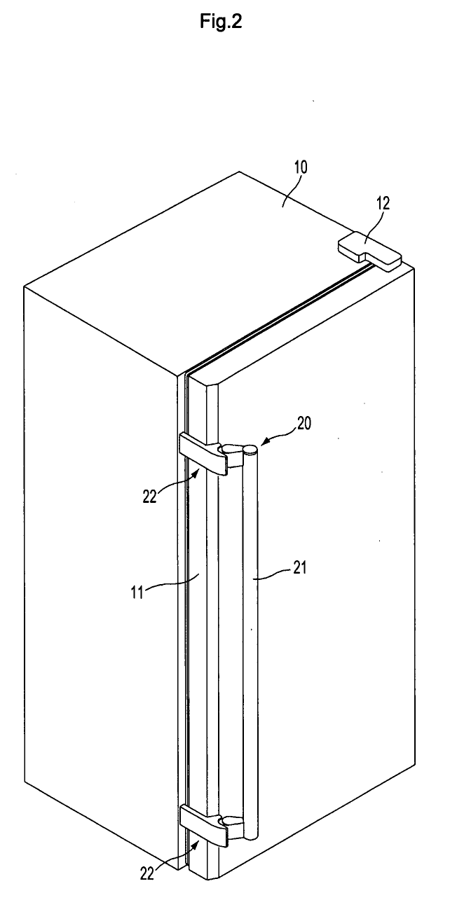

In FIG. 2, a refrigerator according to an embodiment of the present invention comprises a main body 10 having a storage compartment (not shown) defined therein, and a door 11 positioned at a front side of the main body 10 to open or close the storage compartment. The door 11 is hingably coupled at one side with upper and lower portions of the main body 10 via hinge members 12. The door 11 is provided with a door handle 20 to permit easy opening of the door 11 by a user.

The door handle 20 comprises an-elongated pipe-shaped handle 21, and connecting devices 22 to connect upper and lower portions of the handle 21 with upper and lower portions of a side surface of the door 11, respectively. The connecting devices 22 serve not only to connect the handle 21 with the door 11 but also to allow the door 11 to be separated from the main body 10 when the user pulls the handle 21 to open the door 11, thereby permitting easy opening of the door 11. The construction and operation of the door handle 20 will be described hereinafter.

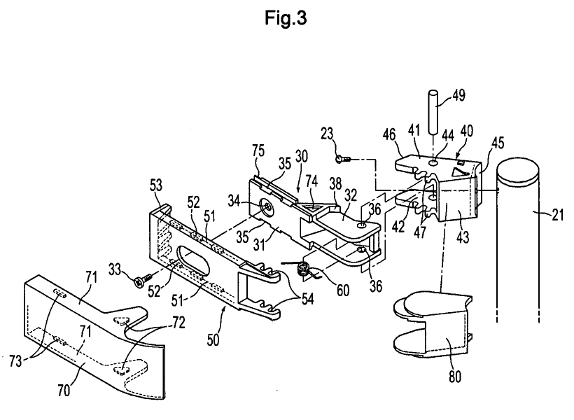

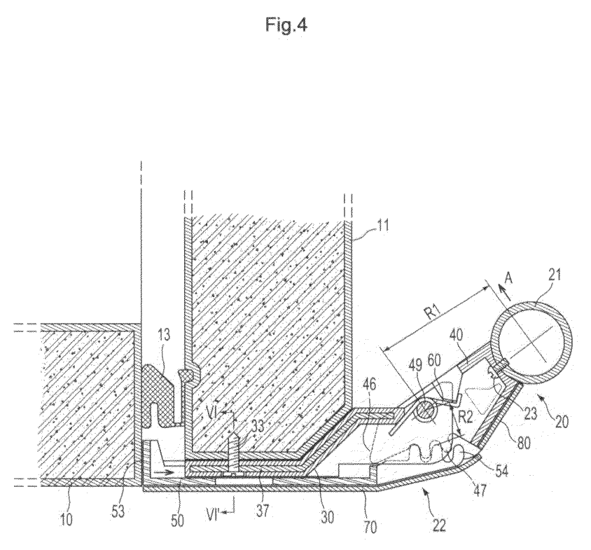

FIGS. 3-6 illustrate a door handle according to a first embodiment of the present invention. In FIGS. 3-4, each connecting device 22 of the door handle 20 comprises a stationary member 30 fixed to the side surface of the door 11, a rotational member 40 rotatably coupled with the stationary member 30, and a compressive member 50 coupled with the stationary member 30 to linearly move by rotation of the rotational member 40. The handle 21 is fastened to the rotational member 40 by means of a fastening screw 23.

As shown in FIG. 3, the stationary member 30 comprises a planar fixed part 31 fixed to the side surface of the door 11, and an extension 32 extending from the fixed part 31 in an opening direction of the door 11 to couple with the rotational member 40. The fixed part 31 is formed with a screw fastening hole 34 to which a fastening screw 33 is fastened such that the fixed part 31 can be secured to the door 11. The fixed part 31 is formed at upper and lower sides with guide grooves 35 in a longitudinal direction such that the compressive member 50 is coupled with the stationary member 30 and moves linearly thereon by means of the guide grooves 35. The extension 32 comprises shaft fitting holes 36 through which a shaft 49 for connection of the rotational member 40 with the stationary member 30 is fitted.

The stationary member 30 is formed of a resin material by injection molding, and comprises a metallic reinforcing material 37 embedded therein as shown in FIG. 4. Hence, although the stationary member 30 has a complicated shape, it can be easily formed and have sufficient stiffness. Alternatively, the overall stationary member 30 is formed of a metallic material or other materials which have sufficient stiffness.

As shown in FIG. 3, the rotational member 40 comprises an upper surface 41, a lower surface 42, and side surfaces 43 connecting the upper and lower surfaces 41 and 42. The upper and lower surfaces 41 and 42 are configured to cover an outer surface of the extension 32 of the stationary member 30, and are respectively formed with shaft fitting holes 44 through which the shaft 49 is fitted to be coupled with the rotational member 40. The rotational member 40 is formed at one end with a round (i.e., curved) engagement part 45 to engage with the handle 21, and at the opposite end with a stopper 46 extending toward the stationary member 30 to restrict excessive rotation of the rotational member 40 when the door 11 is opened. The stopper 46 is supported by supporting steps 38 respectively formed on the upper and lower sides of the stationary member 30 upon rotation of the rotational member 40 while the door 11 is opened, thereby restricting the excessive rotation of the rotational member 40.

The upper and lower surfaces 41 and 42 of the rotational member 40 are respectively formed with pinion gears 47 to transmit the rotation of the rotational member 40 to the compressive member 50. According to an aspect of the present invention, the pinion gears 47 are integrally formed with the rotational member 40. Alternatively, the pinion gears 47 are separately formed, and then affixed to the rotational member 40. The overall rotational member 40 is formed of a metallic material having a large amount of stiffness. Alternatively, with most parts of the rotational member 40 may be formed of a resin material, while only teeth of each pinion gear 47 are formed of the metallic material.

The compressive member 50 comprises a planar shape which covers an outer surface of the stationary member 30, and is provided at upper and lower ends with rims 51 which cover the upper and lower sides of the fixed part 31, respectively. Each of the rims 51 has a plurality of guide protrusions 52 formed on an inner surface of the rim 51 such that each protrusion 52 can be slidably engaged with a corresponding guide groove 35. Thus, enabling the compressive member 50 to move linearly in an opening or closing direction of the door 11 in a state of being coupled with the stationary member 30.

The compressive member 50 further comprises a compressing surface 53 at one end, which has an enlarged area to compress a front side of the main body 10, and at the other end with rack gears 54 extending towards the rotational member 40 to engage with the pinion gears 47 of the rotational member 40, respectively.

The rack gears 54 are positioned on upper and lower sides of a rear end of the compressive member 50 such that the rack gears 54 can engage with the pinion gears 47 formed on the upper and lower surfaces of the rotational member 40, respectively. According to an embodiment of the present invention, the overall compressive member 50 is formed of a resin material or a metallic material.

Alternatively, only the rack gears 54 of the compressive member 50 are formed of the metallic material, and remaining parts thereof are formed of the resin material.

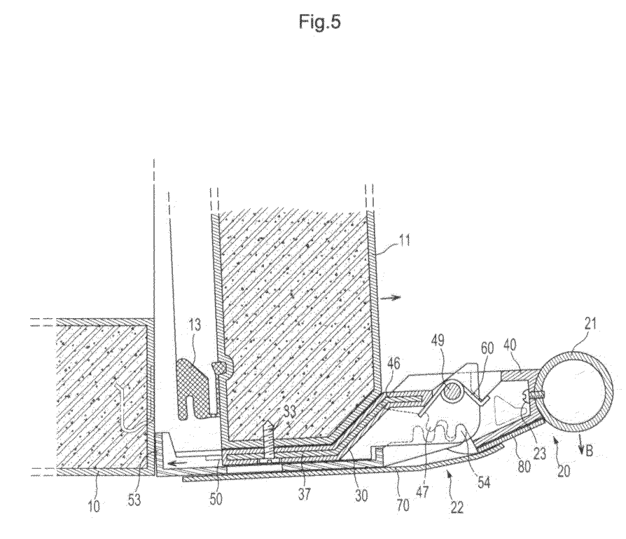

As shown in FIGS. 4 and 5, this configuration of the door handle described above allows rotation of the rotational member 50 generated when the user pulls the handle 21 to be transmitted to the compressive member 50 via the pinion gears 47 and the rack gears 54, and allows the compressive member 50 to move towards and compress the main body 10. Meanwhile, in order to ensure that the force of the compressive member 50 compressing the front side of the main body 10 is greater than the force of the user to pull the handle 21, thereby allowing the door 11 to be opened easily by the user, a rotational radius (R1) of the handle 21 is greater than a rotational radius (R2) of the pinion gears 47, when an operation of the door handle 20 is performed.

The shaft 49 connecting the stationary member 30 with the rotational member 40 comprises a return spring 60 (i.e., a returning member) to return the rotational member 40 to an original location when the user does not pull the handle 21. The return spring 60 is a coil spring, which comprises a center coupled with the shaft 49 and both ends supported by the stationary member 30 and the rotational member 40, respectively.

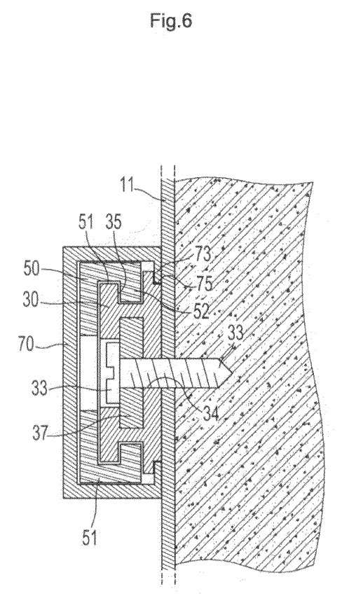

The stationary member 30 and the rotational member 40 comprise first and second covers 70 and 80, which cover outer surfaces of the stationary member 30 and the rotational member 40 to provide an external appearance thereof, respectively. The first cover 70 covers the outer surface of the compressive member 50 to permit a linear movement of the compressive member 50 as shown in FIGS. 3 and 6, and comprises upper and lower rims 71 extending towards the stationary member 30 at upper and lower sides of the first cover 70 and being secured to the stationary member 30. Each of the upper and lower rims 71 of the first cover 70 is formed on an inner surface with first and second securing protrusions 72 and 73, which are secured to first and second securing grooves 74 and 75 formed on each of the upper and lower sides of the stationary member 30. The second cover 80 is configured to cover the upper, lower and side surfaces 41, 42 and 43 of the rotational member 40.

An operation of the door handle constructed as above will be described hereinafter.

In FIG. 4, when a user does not pull the handle 21, the rotation member 40 is rotated in a direction indicated by Arrow A (towards an outer surface of the door) by elasticity of the return spring 60. In addition, since the compressive member 50 engages with the rotational member 40 by means of the pinion gears 47 and the rack gears 54, the compressive member 50 is retracted away from the front side of the main body 10 by rotation of the rotational member 40. Hence, with a gasket 13 inside the door 11 in contact with the front surface of the main body 10, the door 11 is closed.

In FIG. 5, when the user pulls the handle 21 to open the door 11, the rotational member 40 is rotated in a direction indicated by Arrow B. Then, rotation of the rotational member 40 is transmitted to the rack gears 54 of the compressive member 50 through the pinion gears 47 so that the compressive member 50 moves towards and compresses the front side of the main body 10. Hence, the door 11 is opened easily while being separated from the main body 10. At this point, since the rotational radius (R1) of the handle 21 is greater than the rotational radius (R2) of the pinion gears 47, force of the compressive member 50 compressing the front side of the main body 10 is greater than force of the user to pull the handle 21. Accordingly, the door 11 can be opened easily when the user pulls the handle 21 with a small force.

Since the door handle 20 of the present invention enables a rotational force of the rotational member 40 to be transmitted as a compressive force of the compressive member 50 via teeth engagement of the pinion gears 47 with the rack gears 54, it ensures that transmission of force is successfully performed. In other words, little loss occurs during transmission of force. In addition, since there is no slip between the pinion gears 47 and the rack gears 54, not only noise but also damage of an appearance of the door do not occur during the operation of the door handle. Furthermore, since the rack gears 54 of the compressive member 50 are covered by the first cover 70, it is possible to provide a pleasant appearance.

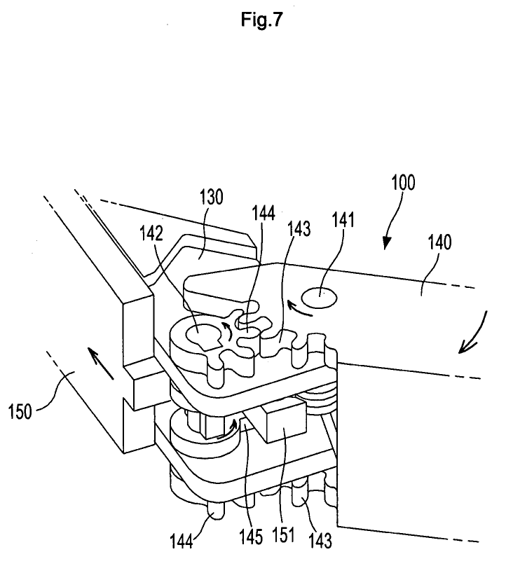

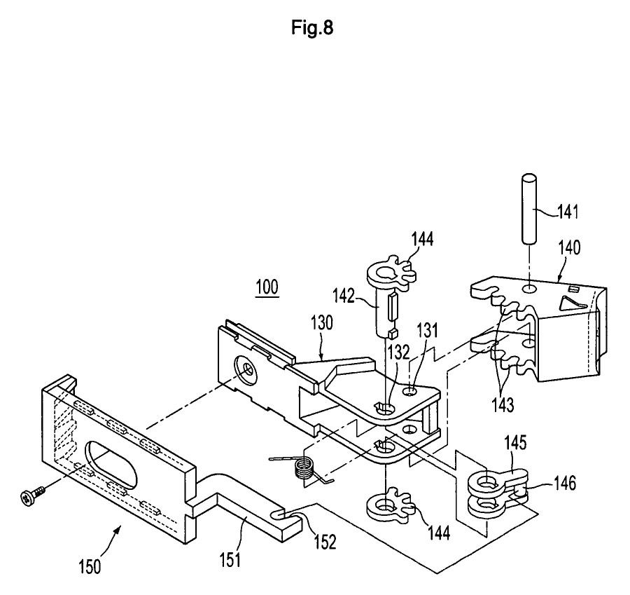

FIGS. 7 and 8 illustrates a door handle according to a second embodiment of the present invention. For a door handle 100 according to the second embodiment, a stationary member 130 comprises first and second shaft fitting holes 131 and 132 formed therein, while being separated from each other. A first shaft 141 is fitted into the first shaft fitting hole 131 to connect with a rotational member 140, and a second shaft 142 is fitted to the second shaft fitting hole 132 so as to be rotated therein.

The second shaft 142 is coupled at either end with a second gear 144 which engages with a first gear 143 of the rotational member 140, and comprises a link member 145 at a central region which rotates along with the second gears 144 by the second shaft 142. The link member 145 is provided with a connecting shaft 146 separated from a rotational center of the link member 145, to connect with a compressive member 150.

The compressive member 150 comprises an extension 151 extending from a rear end of the compressive member 150 to enter a space between the first shaft 141 and the second shaft 142. The extension 151 is formed with a connecting groove 152 to engage with the connecting shaft 146 of the link member 145. The connecting groove 152 is slantly elongated in a direction crossing with a linear movement direction of the compressive member 150, and is open at one side. With this structure, when engaging the connecting shaft 146 with the connecting groove 152, the connecting shaft 146 can be easily engaged with the connecting groove 152 via an opening of the connecting groove 152. Furthermore, the connecting groove 152 is elongated in the direction crossing with the linear movement direction of the compressive member 150, enabling rotation of the link member 145 to be converted to a linear movement of the compressive member 150. Additional elements of the second embodiment are the same as that of the first embodiment, therefore a description thereof will be omitted herein. The door handle 100 of the second embodiment also comprises first and second covers 70, 80, a handle 21, and the like, which are the same as those of the first embodiment.

With the door handle 100 of the second embodiment, as the rotational member 140 is rotated by pulling the handle 21, rotation of the rotational member 140 is transmitted to the second gears 144 through the first gears 143, and rotation of the second gears 144 is transmitted to the link member 145 via the second shaft 142. Then, rotation of the link member 145 is converted to a linear movement of the compressive member 150, and then transmitted to the door 11. Hence, when pulling the handle 21 to open the door 11, the compressive member 50 moves towards and compresses the front side of the main body 10, allowing the door 11 to be opened easily. In addition, for the door handle 100 according to the second embodiment, an output of the compressive member 150 can be adjusted by adjusting gear ratios of the first and second gears 143 and 144 or by adjusting a rotational radius of the handle when manufacturing the door handle. Furthermore, since the door handle of the second embodiment also allows transmission of force from the rotational member 140 to the compressive member 150 by means of the gears and the link member, there is no slip on a power transmission part. Accordingly, the door handle 100 of the second embodiment also enables successful transmission of the force while preventing noise.

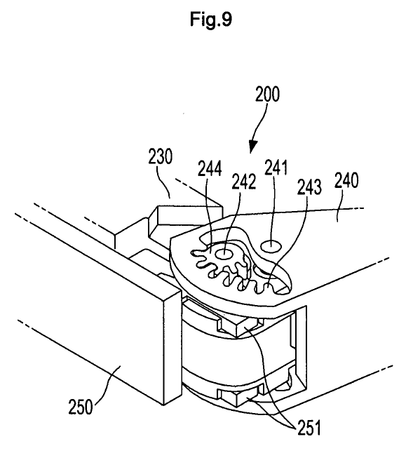

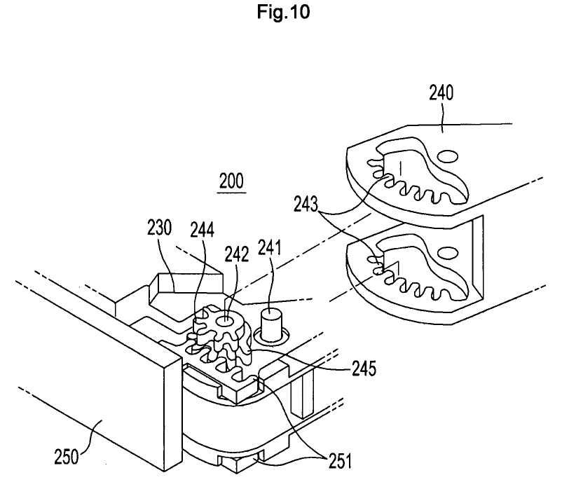

FIGS. 9 and 10 illustrates a door handle 200 according to a third embodiment of the present invention. For a door handle 200 of the third embodiment, a stationary member 230 comprises first and second shafts 241 and 242 separated from each other to connect with a rotational member 240. The rotational member 240 comprises first gears 243, each of which include an internal gear shape, and second gears 244, each including an external gear shape, to engage with the first gears 243. In addition, the second shaft 242 is provided with third gears 245, each of which rotates along with the second gears 244 through the second shaft 242 and includes a greater rotational radius than that of the second gear 244. The third gears 245 engage with rack gears 251 formed at a rear end of the compressive member 250. Here, although the second gears 244 and the third gears 245 are described as separately formed and coupled with the second shaft 242. Alternatively, the second gears 244 may be integrally formed with the third gears 245. Additional elements of the third embodiment are the same as that of the first embodiment, therefore a description thereof will be omitted herein. The door handle 200 according to the third embodiment also comprises first and second covers 70, 80, a handle 21, components for guidance of the compressive member, and the like, which are the same as those of the first embodiment.

With the door handle 200 of the third embodiment, as the rotational member 240 is rotated by pulling the handle 21, rotation of the rotational member 240 is transmitted to the second gears 244 through the first gears 243. Rotation of the second gears 244 is transmitted to the third gears 245 via the second shaft 242, and rotation of the third gears 245 is converted to a linear movement of the compressive member 250, and then transmitted to the door 11. Hence, when pulling the handle 21 to open the door 11, the compressive-member 250 moves towards and compresses the front side of the main body 10, allowing the door 11 to be opened easily.

Regarding the door handle 200 of the third embodiment, an output of the compressive member 250 can be adjusted by adjusting gear ratios of the first, second and third gears 243, 244 and 245 or by adjusting a rotational radius of the handle when manufacturing the door handle 200. Furthermore, since there is no slip on a power transmission part, the door handle 200 of the third embodiment also enables successful transmission of the force while preventing noise.

As apparent from the above description, according to an embodiment of the present invention, since the refrigerator comprises a door handle, of which rotational member and compressive member are engaged with each other by means of gears or a link member, it is possible to successfully convert rotation of the rotational member to a linear movement of the compressive member while preventing slip from occurring where the rotational member compresses the compressive member. Hence, it is possible to prevent damage of an appearance of the door or noise due to an operation of the door handle.

Furthermore, according to an embodiment of the present invention, even when a user pulls the handle with a small force, the compressive member exerts a large force on the front side of a main body of the refrigerator by virtue of gear ratios of the gears connecting the rotational member with the compressive member, thereby allowing the door to be opened easily by the user.

Although few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A refrigerator, comprising a door installed to a main body of the refrigerator, and a door handle installed on the door,
wherein the door handle comprises:
a rotational member rotatably coupled with the door;
a compressive member installed on the door, to move linearly to compress the main body;
a gear connection part to convert a rotational movement of the rotational member to a linear movement of the compressive member; and
a returning member to return the rotational member to an original position.

2. The refrigerator according to claim 1, wherein the gear connection part comprises a pinion gear positioned on the rotational member, and a rack gear positioned on the compressive member, to engage with the pinion gear.

3. The refrigerator according to claim 2, wherein the door handle further comprises:
a stationary member fixed to a side surface of the door, wherein the rotational member is rotatably coupled with the stationary member, and the compressive member is slidably coupled with the stationary member to move linearly in an opening direction of the door.

4. The refrigerator according to claim 3, wherein the stationary member comprises a guide groove to guide the linear movement of the compressive member, and the compressive member comprises a guide protrusion entering and fitted into the guide groove.

5. The refrigerator according to claim 3, wherein the door handle further comprises:
a first cover fixed with the stationary member to cover an outer surface of the compressive member; and
a second cover coupled with the rotational member to cover an outer surface of the rotational member.

6. The refrigerator according to claim 3, wherein the stationary member comprises a resin material having a metallic reinforcing material embedded therein.

7. The refrigerator according to claim 2, wherein the door handle further comprises a handle connected with the rotational member at a location spaced apart from a rotational center of the rotational member, wherein a rotational radius of the handle is greater than that of the pinion gear.

8. The refrigerator according to claim 1, wherein the returning member comprises a return spring to return the rotational member to an original location, when a user does not pull the door handle, wherein ends of the return spring are supported by the stationary member and the rotational member, respectively.

9. A refrigerator, comprising a door installed on a main body of the refrigerator, and a door handle installed to the door,
wherein the door handle comprises:
a stationary member coupled with the door;
a rotational member coupled with the stationary member to rotate by via a first shaft;
a compressive member coupled with the stationary member, to move linearly to compress the main body;
a first gear positioned on the rotational member;
a second gear positioned on the stationary member to rotate via a second shaft, and to engage with the first gear;
a link member being coupled with the second shaft to rotate along with the second gear and comprising a connecting shaft coupled with the compressive member at a location spaced apart from a rotational center of the link member; and
a returning member to return the rotational member to an original position.

10. The refrigerator according to claim 9, wherein the compressive member comprises:
an extension extending to enter a space between the first and second shafts; and
a connecting groove formed on the extension to engage with the connecting shaft.

11. The refrigerator according to claim 10, wherein the connecting groove is slanted elongated in a direction crossing with a linear movement direction of the compressive member, and is open at one side thereof.

12. The refrigerator according to claim 9, wherein the stationary member comprises: a guide groove to guide the linear movement of the compressive member, and the compressive member comprises a guide protrusion entering and fitted into the guide groove.

13. The refrigerator according to claim 9, wherein the door handle further comprises:
a first cover fixed to the stationary member to cover an outer surface of the compressive member; and
a second cover coupled with the rotational member to cover an outer surface of the rotational member.

14. The refrigerator according to claim 9, wherein the door handle further comprises a handle connected with the rotational member at a location spaced apart from a rotational center of the rotational member.

15. A refrigerator, comprising a door installed to a main body of the refrigerator, and a door handle installed to the door,
wherein the door handle comprises:
a stationary member coupled with the door;
a rotational member coupled with the stationary member to rotate via a first shaft;
a compressive member coupled with the stationary member, to move linearly to compress the main body;
a first gear positioned on the rotational member;
a second gear positioned on the stationary member to rotate by means of a second shaft, and to engage with the first gear;
a third gear coupled with the second shaft to rotate along with the second gear;
a rack gear positioned on the compressive member to engage with the third gear; and
a returning member to return the rotational member to an original position.

16. The refrigerator according to claim 15, wherein the first gear is an internal gear which is integrally formed with the rotational member.

17. The refrigerator according to claim 15, wherein the stationary member comprises a guide groove to guide the linear movement of the compressive member, and the compressive member comprises a guide protrusion entering and fitted into the guide groove.

18. The refrigerator according to claim 15, wherein the door handle further comprises:
a first cover fixed with the stationary member to cover an outer surface of the compressive member; and
a second cover coupled with the rotational member to cover an outer surface of the rotational member.

19. The refrigerator according to claim 15, wherein the door handle further comprises a handle connected with the rotational member at a location spaced apart from a rotational center of the rotational member.

20. The refrigerator according to claim 15, wherein the second gear is integrally formed with the third gear.

21. A refrigerator, comprising a door installed to a main body of the refrigerator, and a door handle installed on the door,
wherein the door handle comprises:
a rotational member rotatably coupled with the door, the rotational member including a pinion gear formed at one side of the rotational member and a handle formed at the other side thereof;
a compressive member installed on the door, to move linearly to compress the main body, the compressive member comprising a rack gear engaging with the pinion gear; and
a returning member positioned inside the rotational member to compress and return the rotational member to an original position.
